(19) United States
(12) Patent Application Publication
(10) Pub. No.: US 2025/0328623 A1
(43) Pub. Date: Oct. 23, 2025

(54) SYSTEM AND METHOD FOR DISTRIBUTED AUTONOMY THROUGH ZERO TOUCH SEAMLESS SINGLE SIGN-ON

(71) Applicant: Dell Products L.P., Round Rock, TX (US)

(72) Inventors: Chooi Peng Low, Plano, TX (US); Sumedh Wasudeo Sathaye, Austin, TX (US); Nagasimha G. Haravu, Chapel Hill, NC (US)

(21) Appl. No.: 18/642,947

(22) Filed: Apr. 23, 2024

(51) Int. Cl. G06F 21/41

(52) U.S. Cl. CPC G06F 21/41

(57) ABSTRACT

The disclosure relates to federated single sign-on authentication and to access control autonomy. A service may be configured such that a customer identity service has trust with an orchestration engine of the service. When endpoints are deployed, trust between the endpoints and the customer identity service is established by the orchestration engine on day 0. This allows the endpoints to retain access control autonomy and verify user or application identities. The endpoints may be configured to issue authorization tokens based on identity verifications. The authentication of multiple customers or their users is decentralized with respect to the service while allowing each customer's identity service to be a sole source of ground truth for authentication purposes.

### TECHNOLOGICAL FIELD OF THE DISCLOSURE

Embodiments disclosed herein generally relate to zero trust in computing systems, authentication operations, and/or authorization operations. More particularly, at least some embodiments relate to systems, hardware, software, computer-readable media, and methods for decentralized authorization on operations.

### BACKGROUND

Single sign-on (SSO) is a popular authentication method. Single sign-on allows users to authenticate with related services using one set of credentials. This relieves the user of having to remember multiple sets of credentials. In single sign-on, an authorization token may be generated that allows the user to access multiple applications or services within the single sign-on environment. Typically, a user is not required to present credentials a second time unless, for example, the user's session has expired or terminated.

There are situations, however, where single sign-on becomes complicated. This may include, for example, as-a-Service systems and zero-trust systems. For example, a storage service (e.g., Storage-as-a-Service) provided by a provider typically includes a computing system of distributed endpoints. The endpoints are example of computing systems (e.g., storage systems) that are instantiated and provided to customers.

The provider may use a central identity server/service and an authorization server/service to make identity and access control easier for its central management system. Because single sign-on is popular and desired by users, a user may be required to use the identity service of the storage solution. This allows users of a customer, for example, to access multiple related endpoints with a single sign-on operation. Alternatively, the customer may be required to manually configure their own identity service to work with the identity service of storage solution.

These scenarios create several problems. For example, a customer that uses the identity provider of the storage solution causes user accounts, which already exist in the identity service of the customer, to be duplicated in the identity service of the storage service. This poses a security risk at least because a user that has been terminated by the customer may be removed from the identity service of the customer but may not necessarily be removed from the identity service of the storage service. This may allow the terminated employee to access the customer's endpoints and cause problems. Further, a central authorization service can pose a security risk at least because breaching the identity service of the provider may impact all of the provider's customers.

More specifically, the endpoints included in the distributed ecosystem of the provider's service do not have the option to exercise their own access control policies and may not be able to apply or fulfill their roles in a zero trust architecture.

In addition, the customer may need to manually perform configurations to ensure that the customer's users can access the storage solution using a single sign-on. A customer's identity and access management (IAM) expert may be required to access user interface screens of both the customer's identity service and the identity service of the service provider. This manually performed configuration may lead to errors and may lead to security risks. This process may also delay the availability of single sign-on in the customer's endpoints provided by the provider.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of configuring a computing system for single sign-on and aspects of a method for configuring single sign-on in a computing system;

FIG. 2A discloses aspects of authentication in a computing environment and aspects of an example authentication method;

FIG. 2B discloses aspects of access control autonomy in federated authentication;

FIG. 2C discloses additional aspects of authentication in a computing system;

FIG. 3 discloses aspects of a method for performing authentication operations and/or authorization operations; and

FIG. 4 discloses aspects of a computing device, system, or entity.

### DETAILED DESCRIPTION OF SOME EXAMPLE EMBODIMENTS

Embodiments disclosed herein generally relate to distributed endpoint autonomy using zero touch single sign-on in a computing environment. More particularly, at least some embodiments relate to systems, hardware, software, computer-readable media, and methods for facilitating federated authentication in a computing system or environment. Embodiments of the invention, in one example, allow customers to access a service using their own identity service. This prevents account duplication and protects all customers of the service in the event that a particular customer identity service is compromised.

Embodiments of the invention are discussed in the context of a computing environment or system that deploys or provides endpoints. An endpoint, in one example, is an access point to a service or system, such as a storage/application computing system. An endpoint may also refer to the service or system being deployed. Thus, a storage system and applications running thereon are an example of an endpoint in a provider's service. Customers may use their endpoints for various purposes such data protection, production storage, application execution, or the like.

Federated authentication relates to the ability of multiple endpoints to perform authentication operations and/or authorization operations independently. For instance, a particular customer may be associated with multiple endpoints. Each of these endpoints, in accordance with embodiments of the invention, can be configured to enforce access control, perform authentication operations, determine authorizations or permissions, or the like or combinations thereof.

In one example, an orchestration engine is provided to facilitate federated authentication. The orchestration engine is configured to facilitate authentication that may be performed by the endpoints deployed in a computing system. More specifically, embodiments of the invention programmatically enable endpoints of a customer to perform authentication operations using the customer's identity provider. This removes the need for the provider to provide its own identity service. The provider, however, is not precluded from providing its own identity service. Because each of the customers may use their own identity service, authorization is decentralized and each endpoint is able to authorize or not authorize a user. Further, customers are not reliant on the identity service of the provider and are not subject to breaches of the provider's identity service. For instance, user accounts are not duplicated in the provider's identity service.

The orchestration engine may perform steps or acts to establish trust between an identity service and endpoints in the storage system. Advantageously, a user is able to authenticate using single sign-on as soon as the system is deployed and configured (e.g., day 0). Embodiments of the invention further eliminate the need for the customer's IAM expert to manually configure trust (e.g., on Day 1).

The orchestration engine is configured to programmatically establish trust between each endpoint and a corresponding customer's identity provider or service (different users/customers may be associated with different identity providers or services).

Advantageously, a customer's identity service is the only source of truth for all customer systems (endpoints) in one example. The customer identity service is also the source of truth for the central management service of the provider's service with respect to that customer. Further, each endpoint retains access control autonomy even if management of the provider's service is centralized in a different system. Each endpoint is able to issue its own authorization artifact (e.g., token) after independently verifying user identity. The retention of autonomy is hidden and seamless to the user in one example and uses the user's single sign-on authenticated session.

Aspects of single sign-on authentication are described at www.auth0.com/resources/ebooks/the-openid-connect-handbook (e.g., OpenID), which is incorporated by reference in its entirety. Aspects of single sign-on authentication are also described in www.auth0.com/resources/ebooks/saml-authentication-explained (e.g., SAML authentication), which is also incorporated by reference in its entirety. These are examples of single sign-on authentication.

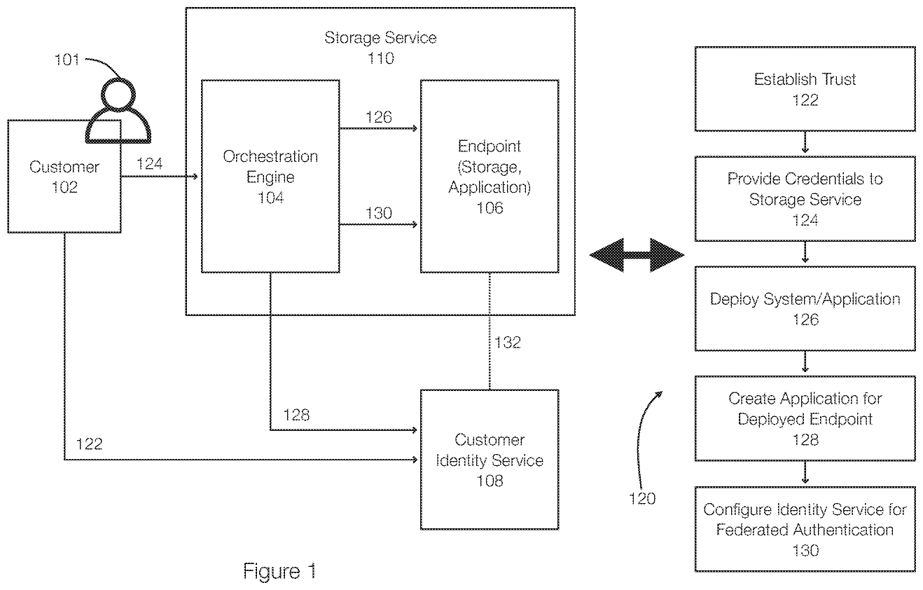

FIG. 1 discloses aspects of configuring a computing system for single sign-on and aspects of a method for configuring single sign-on in a computing system. More specifically, FIG. 1 discloses aspects of a decentralized single sign-on for customers of a service (e.g., Storage-as-a-Service). FIG. 1 illustrates a storage service 110, which may be an example of an as-a-Service. The storage server 110 may provide multiple customers with access to computing systems (e.g., processors, memory, storage) that can be used for, by, or with various applications. The storage service 110 may be cloud-based, edge-based, on-premise, or the like or combinations thereof.

In this example, the storage service 110 may include an orchestration engine 104. The orchestration engine 104 may provide an interface accessed by customers or clients of the storage service. The storage service 110 illustrates an endpoint (or target) 106, which may be a server cluster, a storage cluster, or the like or combination thereof.

In this example, a customer 102 may be associated with their own customer identity service 108, which is configured to authenticate users. For example, each user associated with the customer 102 may be associated with credentials (e.g., username/password) that can be verified by the customer identity service 108. The customer identity service 108 is distinct from an identity service that may be provided by the storage service 110.

Embodiments of the invention are configured such that the customer identity service 108 is the only source of truth for the storage service 110 in the context of the customer 102. Other customers may similarly use the storage service 110 using their own customer identity service. Embodiments of the invention allow each customer's identity service to be used as a single source of truth, at least for authentication operations, in the storage service 110.

In the method 120, trust is established 122, by the customer 102, in the customer identity service 108 for the orchestration engine 104 and the endpoint 106 (or application). In one example, the customer 102 may establish an orchestration identity for the orchestration engine 104 and an endpoint identity for the endpoint 106 in the customer identity service 108. The ability of the endpoint 106 and the orchestration engine 104 to verify identities or authenticate users using the customer identity service 108 facilitates not only authentication operations but also authorization operations. Thus, the autonomy of the endpoint 106 is retained in the context of a user's single sign-on session. Further, the autonomy of the endpoint 106 is not bounded by a single sign-on session. The endpoint 106 also has autonomy for scripted API calls (e.g., non-browser requests) at least because the endpoint 106 independently verifies the user's access. Embodiments of the invention, which decentralize authorization, then enable the endpoint 106 to have autonomy for access requests independent of how the access request is received

Once trust is established 122 in the customer identity service 108, credentials of the orchestration engine 104 are provided 124 to the orchestration engine 104. Once deployed, the endpoint 106 may also receive credentials into the customer identity service 108. Alternatively, embodiments of the invention establish trust 132 between the endpoint 106 and the customer identity service 108 such that the endpoint 106 can verify user identities.

In one example, the orchestration engine 104 receives the credentials of a user 101) or customer 102) into the customer identity service 108 and an instruction to deploy an application. Thus, the endpoint is deployed 126 within the storage service 110. The endpoint 106 may include an application and hardware.

The orchestration engine 104 may create 128 an application for the deployed endpoint 128. This may include providing certain metadata to the customer identity service 108 such that trust can be established for the endpoint 106 (and/or applications thereon). Thus, the identity service is configured 130 for federated authentication. This may include providing credentials to the customer identity service 108 to the endpoint 106 (or application thereof) or configuring the customer identity service 108 such that the endpoint 106 can verify a user's identity.

The method 120 more generally represents a method for configuring single sign-on in a manner that provides the endpoint 106 with access control autonomy and that uses the customer identity service 108 as the only source of truth for the customer 102 and endpoints related to the customer 102. More specifically, the endpoint 106 retains access control autonomy even if management of the storage service 110 is centralized in a different system. Each endpoint, including the endpoint 106, can issue an authorization artifact or token independently after verifying user identity. Once the storage service 110 or more specifically, the endpoint 106, is configured as illustrated in the method 120, trust 132 is established between the endpoint 106 and the customer identity service 108.

FIG. 1 illustrates that the process of deploying a system/application in the storage service 110 can programmatically establish trust between the endpoint 106 and the customer identity service 108. Thus, a target (e.g., orchestration engine 104, endpoint 106) of a request can authenticate the user generating the request with the customer identity service 108. This may include verifying a user's authentication token, which may be generated by the customer identity service 108. Users, such as the user 101, can access and use the endpoint 106 without requiring the customer 102 to perform configurations allowing different identity services to coordinate. The authentication is federated at least in the sense that the various endpoints of a customer each have a trust relationship with the customer identity service 108.

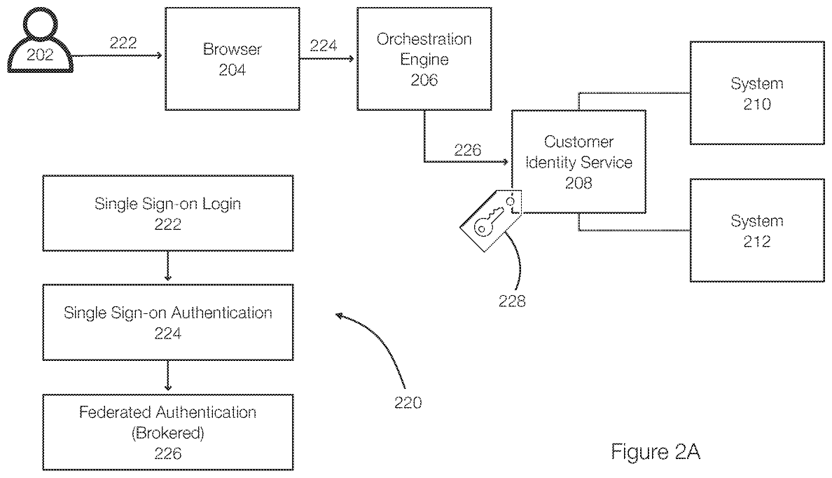

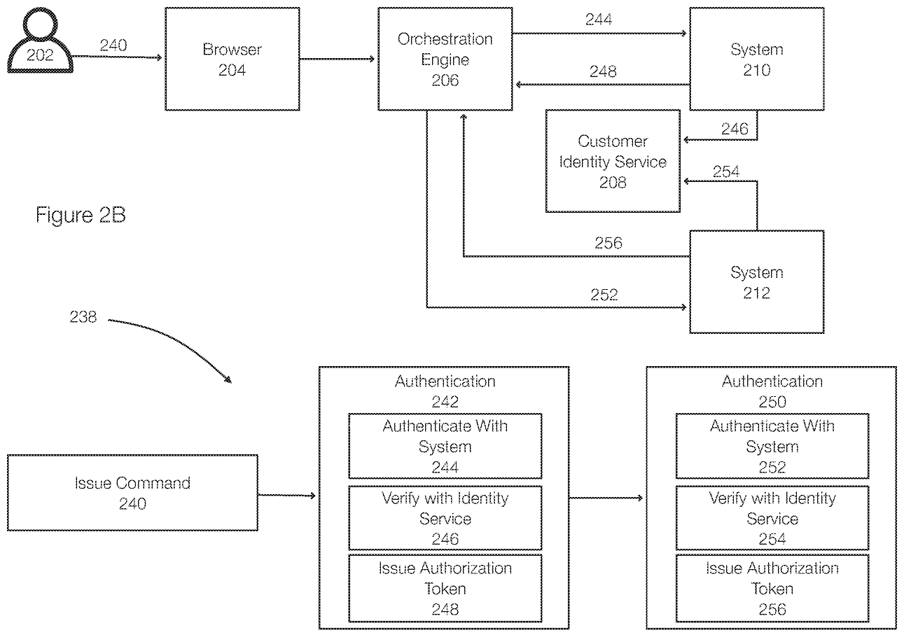

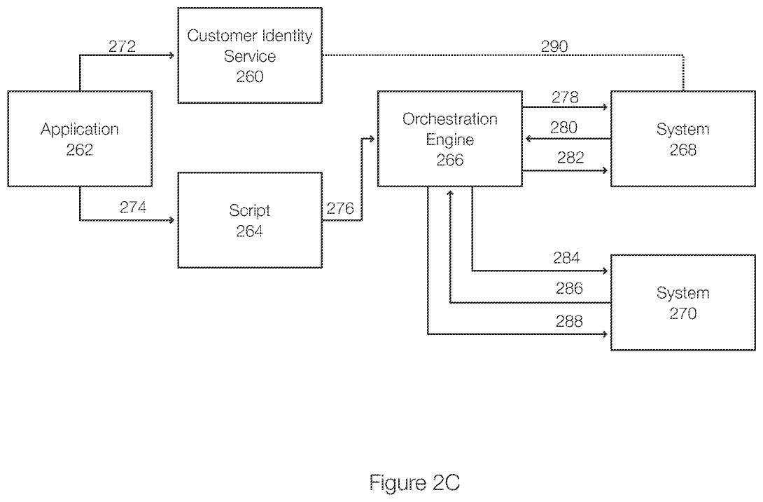

FIG. 2A discloses aspects of authentication in a computing environment, such as Storage-as-a-Service, and aspects of example authentication operations. FIG. 2A illustrates a method 220 for authenticating a user in a system supporting federated authentication. A user 202 may use a browser 204 to perform 222 a single sign-on login operation. This may include providing username/password.

In this example, the browser 204 may connect to or access an orchestration engine 206 using a uniform resource locator (URL). Thus, the browser 204 may initiate a single sign-on authentication 224. The orchestration engine 206 may perform a brokered authentication such that an authentication 226 is performed with the customer identity service 208. The method 220 may establish a session for the single sign-on session of the browser 204 (or user 202). In this example, the orchestration engine 206 has no visibility into the credentials of the user 202 as the authentication request is redirected or brokered. In one example, a token 228 is generated and returned by the customer identity service 208. In one example, the token is returned to the browser 204 may be used for other identity authentications. The token 228, for example, may be signed such that the token cannot be modified.

FIG. 2A also illustrates systems 210 and 212, which are examples of endpoints. The deployed systems 210 and 212 retain access control in embodiments of the invention. Communication with the systems 210 and 212 may be performed using tokens or authorization artifacts issued by the systems 210 and 212. Authentication may be performed by the systems 210 and 212 using the token 228, which may be passed during various communications.

In another example, the token 228 is not passed. Because the orchestration engine 206 federated a customer's endpoints to the customers identity service, the endpoints (e.g., the systems 210 and 212) may independently perform user authentication with the customer's identity service. The systems 210 and 212 may perform their own redirected authentication request via the browser 204 with the customer identity service 208 and obtain their own respective tokens from the customer identity service 208 upon successful identity verification.

FIG. 2B discloses aspects of access control autonomy in federated authentication and a method of access control autonomy. FIG. 2B assumes that a session for the user 202 was established in FIG. 2A and that an authentication token exists in one example. In FIG. 2B, a user 202 may interact with a browser 204. Thus, in the method 238, a command 240 (or request or other input) may be received into the browser 204. The command is received by the orchestration engine 206 along with the token of the user 202.

Because embodiments of the invention relate to zero trust architectures, authentication 242 may be performed. The authentication 242 and 250 allow the systems 210 and 212 to obtain, respectively, tokens from the customer identity service 208. The system 210 may communicate with the customer identity service 208 to verify the identity of the user 202. The system 210 may receive an authentication token from the customer identity service 208.

Once verified, the system 210 may generate or issue 248 an authorization token that is provided back to the orchestration engine 208 or more specifically to the browser 204/user 202. In this example, the system 210, which issued the authorization token, has access control autonomy with regard to the system 210. The authorization token or artifact may define, in one example, permissions or access rights of the user 202.

Once the user 202 is authenticated, the command may be passed to the system 210 along with the authorization token. The authorization token issued by the system 210 may be used to determine whether the command or request of the user 202 is actually performed—the decision is made by the system 210. Even if the user 202 is authenticated, the authorization and access control is maintained by the system 210.

In this example, it is assumed that the authorization token allows the user 202 to perform the command or request. If the command 240 is to copy data from the system 210 to the system 212, an authentication 250 is performed with respect to the system 212. In a similar manner, the orchestration engine 206 may authenticate 252 the user 202 with the system 212. The system 212 verifies 254 the identity of the user 202 using the authentication token with the customer identity service 208, and may issue 256 a second authorization token back to the orchestration engine 206. Thus, each of the systems 210 and 212 can issue their own authorization tokens.

This further demonstrates that each of the endpoints (the system 210 and 212) retain access control autonomy. Thus, even if the system 210 allows the command of the user to be performed, the system 212 may not allow authorize the requested action or operation. For example, the target endpoint of the move command may be misidentified and the system 212 may not authorize the operation.

By establishing the customer identity service 208 as the sole ground truth authority, embodiments of the invention also allow endpoints to retain their autonomy with regard to access control and operations performed with respect to the system 210. The ability to provide single-sign-on capabilities using customer identity services while maintaining endpoint autonomy may further enhance the zero trust aspects of the system illustrated in FIG. 2B.

FIG. 2C discloses additional aspects of authentication in a computing system. FIG. 2C illustrates aspects of a customer identity service being a source of truth for non-browser scenarios and/or non-human scenarios. In this example, an application 262 (or other non-human) may authenticate 272 with a customer identity service 260 and receive an authentication token. In one example, trust 290 between the system 268 and the customer identity service 260 was previously established by the orchestration engine 266. The application 262, in an example embodiment, may be a management API that uses single sign-on credentials to perform management operations from a command line.

The application 262 then provides 274 a token (e.g., received from the customer identity service 260, in or with a script 264. The script 264, with the authentication token, is provided 276 to the orchestration engine 266 or to the system 268 via the orchestration engine 266.

In this example, the script 264 may be to copy the system 268 to the system 270. The orchestration engine 266 may exchange 278 the authentication token for a token of the system 268. More specifically, the system 268, which has a trust relationship 290 with the customer identity service 260, may verify the identity of the application 262 and issue 280 an authorization token.

Next, the authentication token received from the customer identity service 260 is exchanged 284 with the system 270. This may include the system 270 verifying the identity of the application 262 using the authentication token. The system may thus verify the authentication token and issue 286 an authorization token.

Thus, the orchestration engine 266 (or application 262) has a first authorization token from the system 268 and a second authorization token from the system 270. These authorization tokens allow the script 264 to be performed 282, 288. Thus, the system 268 is copied to the system 270.

FIG. 2C thus illustrates an example of a single sign-on using a customer identity service 260 as the source of truth for a non-browser scenario. This allows management of the storage service to use single sign-on credentials to perform operations from the command line.

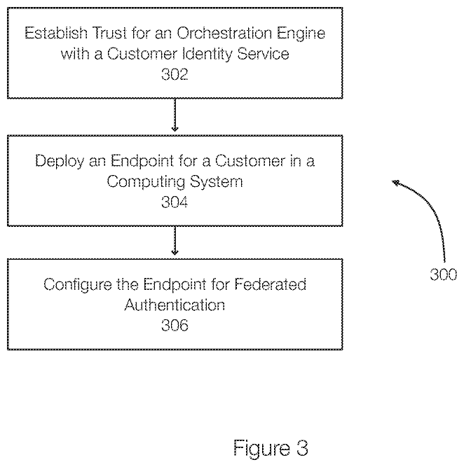

FIG. 3 discloses aspects of performing authentication operations and/or authorization operations in a computing system such as a service or other computing environment. The method 300 includes establishing 302 trust for an orchestration engine of a service with a customer identity service. The orchestration engine may be able to communicate with multiple customer identity services. Next, an endpoint is deployed 304 in the computing system. This may include allocating resources to a customer such that users, applications, or the like can access and use the resources.

The method 300 the configures 306 the endpoint for federated authentication. More specifically, the method 300 programmatically establishes trust between the deployed endpoint and the customer identity service. This allows the endpoint to maintain access control autonomy and issue authorization tokens upon successful user identify (or application or non-human) verification. Further, in the event that the customer identity service is breached or compromised, other customers of the computing system or service are unaffected by the breach. Thus, the single sign-on operations are centralized and federated with respect to a customer, but decentralized with respect to the service provided by the provider.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, clustering operations, interactive graph operations, scaling operations, asset management operations, visualized asset management operations, policy recommendation operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operations of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method for facilitating authentication and authorization in a computing system configured to provide at least one service, the method comprising: establishing trust for an orchestration engine with a customer identity service, wherein orchestrator credentials to the customer identity service are provided to the orchestration engine, deploying an endpoint for a customer in the computing system, and configuring the endpoint with federated authentication such that trust is established between endpoint and the customer identity service, wherein the endpoint has access control autonomy.

Embodiment 2. The method of embodiment 1, wherein users associated with the customer are able to access the endpoint using credentials verified by the customer identity service on day 0 of a deployment.

Embodiment 3. The method of embodiment 1 and/or 2, further comprising providing endpoint credentials to the customer identity service to the endpoint.

Embodiment 4. The method of embodiment 1, 2, and/or 3, wherein the trust between endpoint and the customer identity service is established programmatically.

Embodiment 5. The method of embodiment 1, 2, 3, and/or 4, further comprising authenticating a user associated with the customer, wherein the orchestration engine brokers authentication of a user when a user signs into the computing system using a single sign-on verified by the customer identity service.

Embodiment 6. The method of embodiment 1, 2, 3, 4, and/or 5, further comprising receiving a command from a user via a browser, wherein the endpoint receives a token associated with the user and verifies an identity of the user with the customer identity service.

Embodiment 7. The method of embodiment 1, 2, 3, 4, 5, and/or 6, wherein the endpoint generates an authorization token that is associated with the user.

Embodiment 8. The method of embodiment 1, 2, 3, 4, 5, 6, and/or 7, further comprising performing the command, wherein the endpoint determines whether the command is authorized in the authorization token such that the access control autonomy is held by the endpoint and wherein the customer identity service is a sole source of ground truth with respect to the customer and the computing system.

Embodiment 9. The method of embodiment 1, 2, 3, 4, 5, 6, 7, and/or 8, wherein multiple endpoints associated with the customer are deployed in the computing system and wherein each of the multiple endpoints has their own access control autonomy.

Embodiment 10. The method of embodiment 1, 2, 3, 4, 5, 6, 7, 8, and/or 9, further comprising authenticating an application with the customer identity service and receiving a script associated with the application.

Embodiment 11. The method of embodiment 1, 2, 3, 4, 5, 6, 7, 8, 9, and/or 10, further comprising exchanging an authorization token of the application for an authorization token of the endpoint and performing the script at the endpoint when allowed by the authorization token issued by the endpoint.

Embodiment 12. A method comprising: in a service that includes a computing system, providing an orchestration engine of the service with orchestration credentials from a customer identity service and providing a deployed endpoint with endpoint credentials from the customer identity service, wherein the orchestration engine established trust between the customer identity service and the deployed endpoint programmatically, and receiving a command from a user that authenticates using single sign-on with the customer identity system, wherein the deployed endpoint is configured to retain access control autonomy and is configured to issue an authorization token for the user if an identity of the user is verified by the customer identity service.

Embodiment 13. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

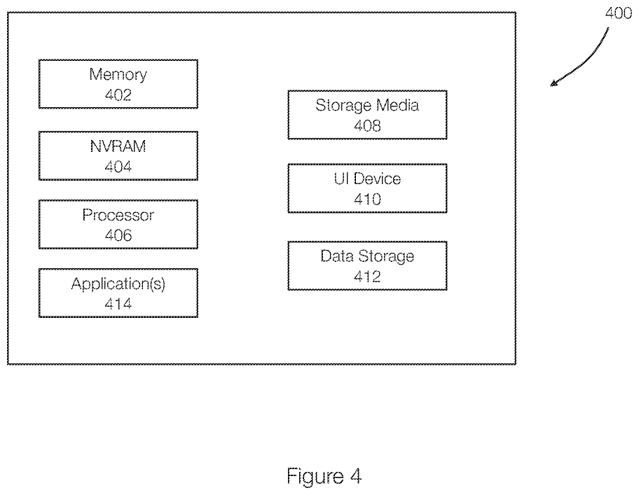

With reference briefly now to FIG. 4, any one or more of the entities disclosed, or implied the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for facilitating authentication and authorization in a computing system configured to provide at least one service, the method comprising:
establishing trust for an orchestration engine with a customer identity service, wherein orchestrator credentials to the customer identity service are provided to the orchestration engine;
deploying an endpoint for a customer in the computing system; and
configuring the endpoint with federated authentication such that trust is established between endpoint and the customer identity service, wherein the endpoint has access control autonomy.

2. The method of claim 1, wherein users associated with the customer are able to access the endpoint using credentials verified by the customer identity service on day 0 of a deployment.

3. The method of claim 1, further comprising providing endpoint credentials to the customer identity service to the endpoint.

4. The method of claim 1, wherein the trust between endpoint and the customer identity service is established programmatically.

5. The method of claim 1, further comprising authenticating a user associated with the customer, wherein the orchestration engine brokers authentication of a user when a user signs into the computing system using a single sign-on verified by the customer identity service.

6. The method of claim 1, further comprising receiving a command from a user via a browser, wherein the endpoint receives a token associated with the user and verifies an identity of the user with the customer identity service.

7. The method of claim 6, wherein the endpoint generates an authorization token that is associated with the user.

8. The method of claim 7, further comprising performing the command, wherein the endpoint determines whether the command is authorized in the authorization token such that the access control autonomy is held by the endpoint and wherein the customer identity service is a sole source of ground truth with respect to the customer and the computing system.

9. The method of claim 1, wherein multiple endpoints associated with the customer are deployed in the computing system and wherein each of the multiple endpoints has their own access control autonomy.

10. The method of claim 1, further comprising authenticating an application with the customer identity service and receiving a script associated with the application.

11. The method of claim 10, further comprising exchanging an authorization token of the application for an authorization token of the endpoint and performing the script at the endpoint when allowed by the authorization token issued by the endpoint.

12. A non-transitory storage medium having stored therein instructions that are executable by one or more hardware processors to perform operations for facilitating authentication and authorization in a computing system configured to provide at least one service, the operations comprising:
establishing trust for an orchestration engine with a customer identity service, wherein orchestrator credentials to the customer identity service are provided to the orchestration engine;
deploying an endpoint for a customer in the computing system; and
configuring the endpoint with federated authentication such that trust is established between endpoint and the customer identity service, wherein the endpoint has access control autonomy.

13. The non-transitory storage medium of claim 12, wherein users associated with the customer are able to access the endpoint using credentials verified by the customer identity service on day 0 of a deployment, wherein the trust between endpoint and the customer identity service is established programmatically.

14. The non-transitory storage medium of claim 12, further comprising:
providing endpoint credentials to the customer identity service to the endpoint; and
authenticating a user associated with the customer, wherein the orchestration engine brokers authentication of a user when a user signs into the computing system using a single sign-on verified by the customer identity service.

15. The non-transitory storage medium of claim 12, further comprising receiving a command from a user via a browser, wherein the endpoint receives a token associated with the user and verifies an identity of the user with the customer identity service, wherein the endpoint generates an authorization token that is associated with the user.

16. The non-transitory storage medium of claim 15, further comprising performing the command, wherein the endpoint determines whether the command is authorized in the authorization token such that the access control autonomy is held by the endpoint and wherein the customer identity service is a sole source of ground truth with respect to the customer and the computing system.

17. The non-transitory storage medium of claim 12, wherein multiple endpoints associated with the customer are deployed in the computing system and wherein each of the multiple endpoints has their own access control autonomy.

18. The non-transitory storage medium of claim 12, further comprising authenticating an application with the customer identity service and receiving a script associated with the application.

19. The non-transitory storage medium of claim 18, further comprising exchanging an authorization token of the application for an authorization token of the endpoint and performing the script at the endpoint when allowed by the authorization token issued by the endpoint.

20. A method comprising:
in a service that includes a computing system, providing an orchestration engine of the service with orchestration credentials from a customer identity service and providing a deployed endpoint with endpoint credentials from the customer identity service, wherein the orchestration engine established trust between the customer identity service and the deployed endpoint programmatically; and
receiving a command from a user that authenticates using single sign-on with the customer identity system, wherein the deployed endpoint is configured to retain access control autonomy and is configured to issue an authorization token for the user if an identity of the user is verified by the customer identity service.
